(19) United States
(12) Patent Application Publication
(10) Pub. No.: US 2014/0083131 A1
(43) Pub. Date: Mar. 27, 2014

(54) DEVICE FOR DIRECTLY REFRIGERATING THE SKEWER OF KEBAB MEAT ON THE ROTARY SPIT AFTER THE LATTER HAS STOPPED TURNING

(71) Applicants: Jacques Costa-Solar, Bargemon (FR); Isabelle Abad, Bargemon (FR)

(72) Inventors: Jacques Costa-Solar, Bargemon (FR); Isabelle Abad, Bargemon (FR)

(21) Appl. No.: 14/115,588

(22) PCT Filed: May 4, 2012
(86) PCT No.: PCT/FR12/00179

§ 371 Date: Nov. 4, 2013

(30) Foreign Application Priority Data
May 5, 2011 (FR) 11/01395

(51) Int. Cl. A23L 3/36

(52) U.S. Cl. CPC A23L 3/363
USPC 62/452; 62/465

(57) ABSTRACT

Device for refrigerating the skewer of kebab meat directly on the rotary spit, after the latter has stopped turning, and for limiting the exposure of the skewer of meat to the ambient air, to insects and to dust. The invention relates to a device that allows the skewer of meat to be kept in position on the rotary spit by diffusing coldness released by the layer of eutectic gel contained in the jacket and frozen to −18° C. It consists of a set of éléments that form the kebab cover comprising, according to embodiment 1, a layer made up of a multitude of pockets containing eutectic gel (8) inserted in a jacket (1) positioned around a disc (2) and resting on the upper part of the skewer of meat. The jacket will therefore adopt a cylindrical shape hugging the skewer and will be closed at the top and the bottom by laces (3). The jacket will be held vertically by magnetized male/female plastic fasteners (6). Advantageously, according to embodiment 2, it consists of a layer made up of a multitude of pockets containing eutectic gel (8) and of a thermal reflector (10), which are inserted in a jacket (9) that has slits (15) in its upper part, fitting into the crenulations of a disc (11), the latter on its surface having holes or slots (16) and being held at the desired height by a square tube (13), that forms an integral part of the disc, that is fixed over the spit skewer of the rotary spit using a screw or a knob (14). The jacket (9) will therefore adopt a cylindrical shape hugging the skewer, and will be closed at the top and the bottom by fastening clips (12), while still allowing air to circulate within the device. The device according to the invention is particularly intended for refrigerating foodstuffs that are sensitive to variations in température, specifically skewers of kebab meat, protecting the meat that is exposed when the rotary spit stops turning.

This invention is a device that adapts to the rotary spit used for cooking doner kebab meat. It is used, once the rotary spit has been turned off, to refrigerate the remaining kebab meat without removing it from the spit, thanks to the diffusion of coldness from a layer of eutectic gel in the device that has been frozen to a temperature of −18° C., and also to protect the kebab meat by limiting its exposure to air, insects and dust. This device will maintain a cylindrical shape around the skewer of the rotary spit, without coming into contact with the kebab meat, by means of a disc positioned on the skewer of the rotary spit, and will be reusable and easy to wash thanks to the properties of the materials it is composed of.

Doner kebab meat is traditionally conserved in aluminium foil and not refrigerated, a method which incurs the risk of bacterial growth on the surface of the meat once the rotary spit has been turned off.

Certain types of aluminium foil have properties that allow the user to protect the kebab meat from attack by insects, but they do not eliminate the risk of bacterial growth due to an excessively high temperature.

The device according to the invention offers a remedy to this problem. In fact, the primary characteristic of embodiment 1 of this invention is a jacket with one side that insulates (outer side) and one side that conducts the cold (inner side). Inside this jacket there is a layer made up of a multitude of pockets containing eutectic gel, which has been frozen to a temperature of −18° C. The distinctive feature of this layer of eutectic gel is that it is supple and will take on the cylindrical shape of the whole kebab meat cover, thereby cooling down the meat in a homogeneous way. In order that no part of the cover might come into direct contact with the kebab meat, the upper part of it will be supported by a disc made of either a polyamide type of plastic, or, more advantageously, stainless steel, which will be positioned on the skewer of the rotary spit. In order to reduce natural condensation and facilitate the cooling effect, the disc will be ventilated and the lower part of the jacket will not be completely airtight when closed. This will allow for the circulation of air and facilitate the diffusion of coldness from the layer of eutectic gel.

In fact, the primary characteristic of embodiment 2 of this invention is a jacket composed, on the outer side, of supple, food grade material and, on the inner side, of supple, food grade material that allows the diffusion of coldness from the layer of eutectic gel. Inside this jacket are two elements. The first is a layer made up of a multitude of pockets containing eutectic gel that has been frozen to a temperature of −18° C. This diffuses coldness in a homogeneous way. The second is a thermal reflector, which encourages the diffusion of coldness towards the kebab meat skewer. These elements present the primary characteristic of being supple so they can take on a cylindrical shape when covering the whole of the kebab meat skewer without coming into contact with it. These elements will be permanently and hermetically contained within the jacket, which will be entirely sealed to avoid food deposits and bacterial attacks on the inside. In order that no part of the cover might come into contact with the kebab meat, its upper part will be supported by a rigid disc, made of either a polyamide type of plastic or stainless steel, which has crenulations that allow the whole length of the jacket to be attached; the upper part of the jacket including slits for this purpose. The disc will have holes or slots on its surface and the cover surrounding the kebab meat skewer will not be completely airtight in its lower part, in order to reduce natural condensation and facilitate the diffusion of coldness by the circulation of air inside the device.

The jacket, as described above, will be placed in a freezer until the layer of eutectic gel it contains has frozen to a temperature of −18° C.

The materials used on the outer sides of the jacket will have received all the certifications of compatibility for use with food that this application requires.

According to the particular embodiments:
Skewers of kebab meat varying in weight, the layers of eutectic gel will be of varying weights and sizes.
The annexed drawings apply to kebab meat skewers of varying weights and sizes.

The annexed drawings illustrate the invention:

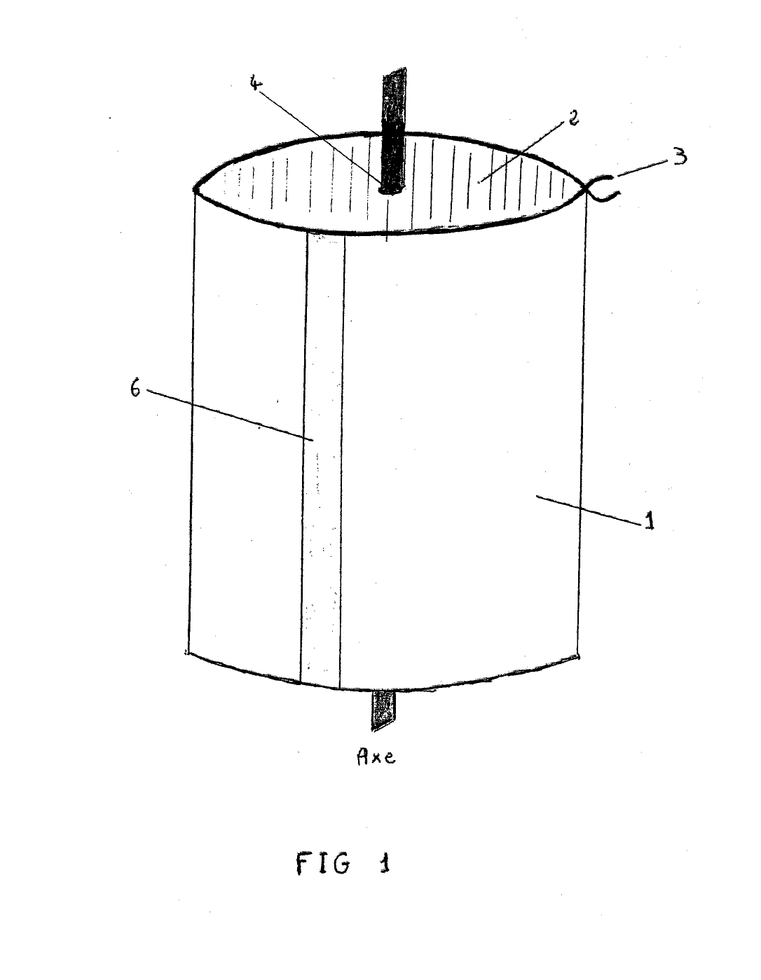

FIG. 1 represents the kebab meat cover as it is when surrounding the skewer (according to embodiment 1.)

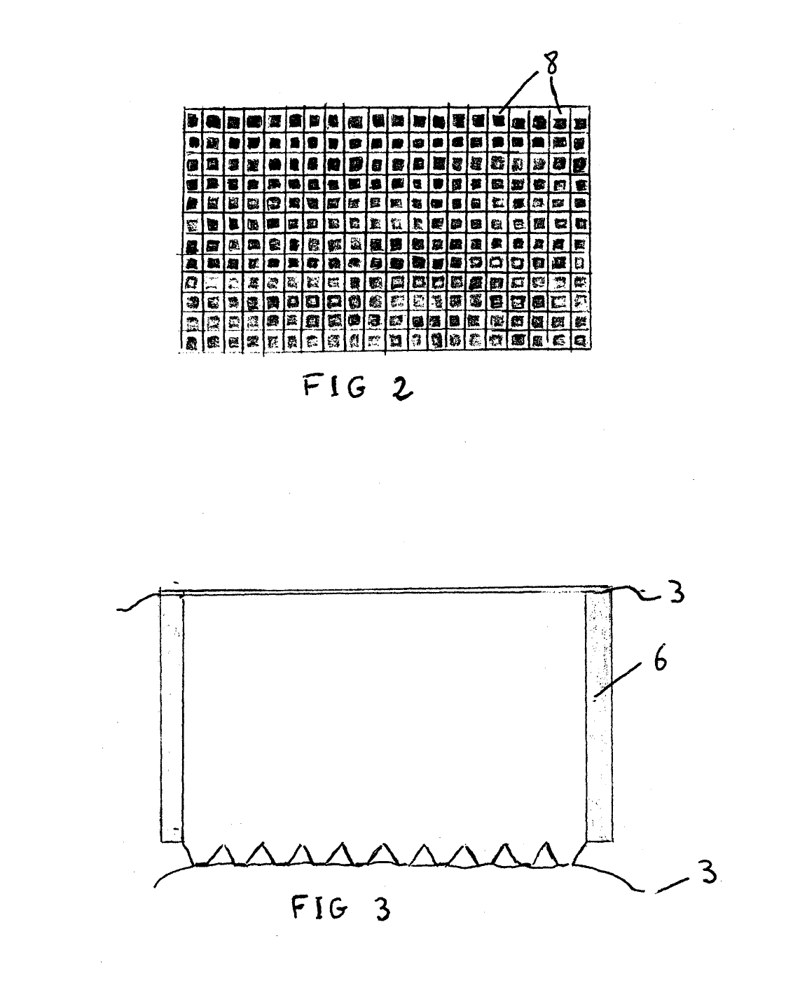

FIG. 2 represents the layer made up of a multitude of pockets containing eutectic gel (according to embodiment 1 and embodiment 2).

FIG. 3 represents the jacket containing the layer of eutectic gel, which allows the skewer of kebab meat to be completely surrounded (according to embodiment 1).

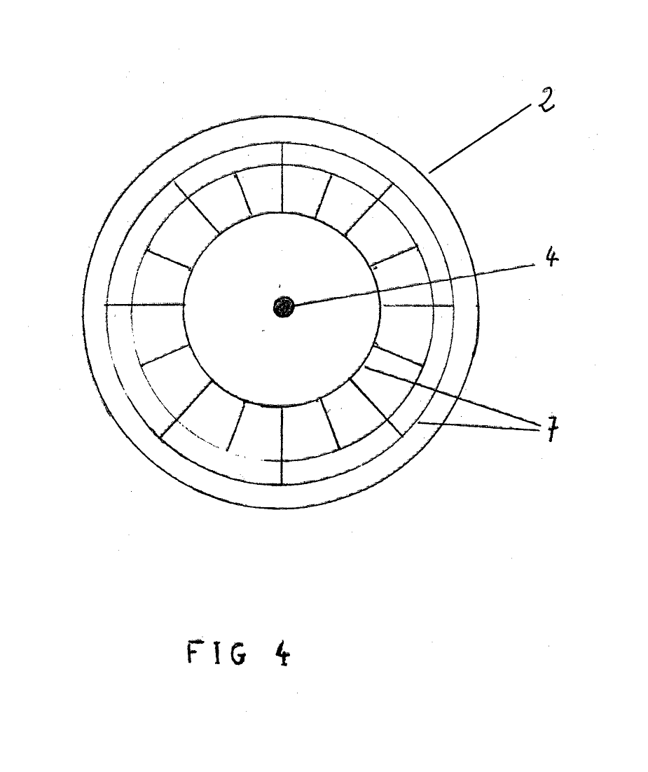

FIG. 4 represents the disc that supports the jacket (according to embodiment 1).

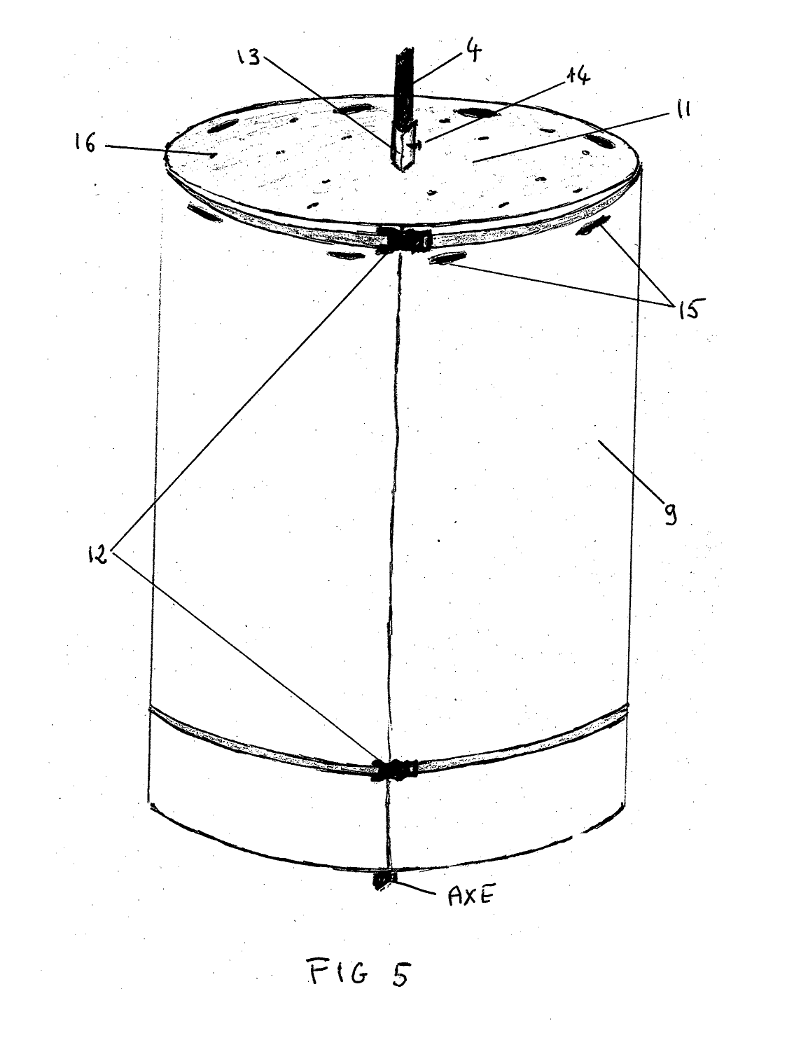

FIG. 5 represents the kebab meat cover as it is when surrounding the skewer (according to embodiment 2).

FIG. 6 represents the jacket containing the layer of eutectic gel and the reflector (according to embodiment 2).

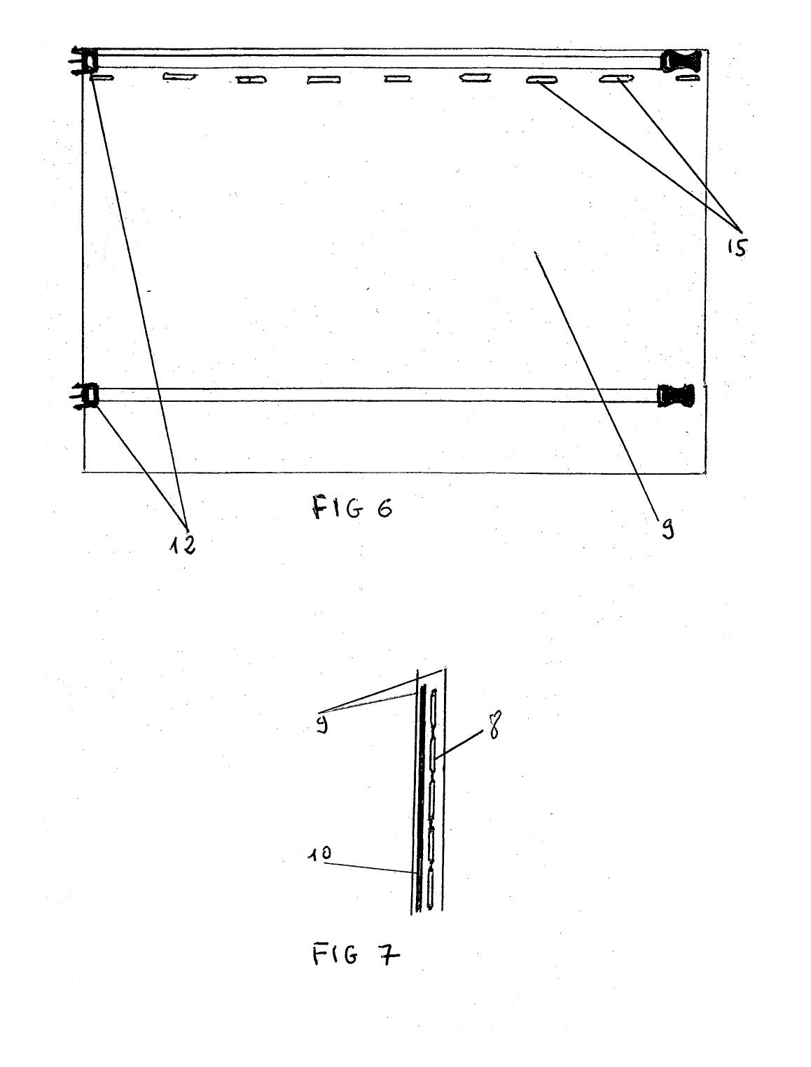

FIG. 7 represents a cross-section of the different materials inside the jacket (according to embodiment 2).

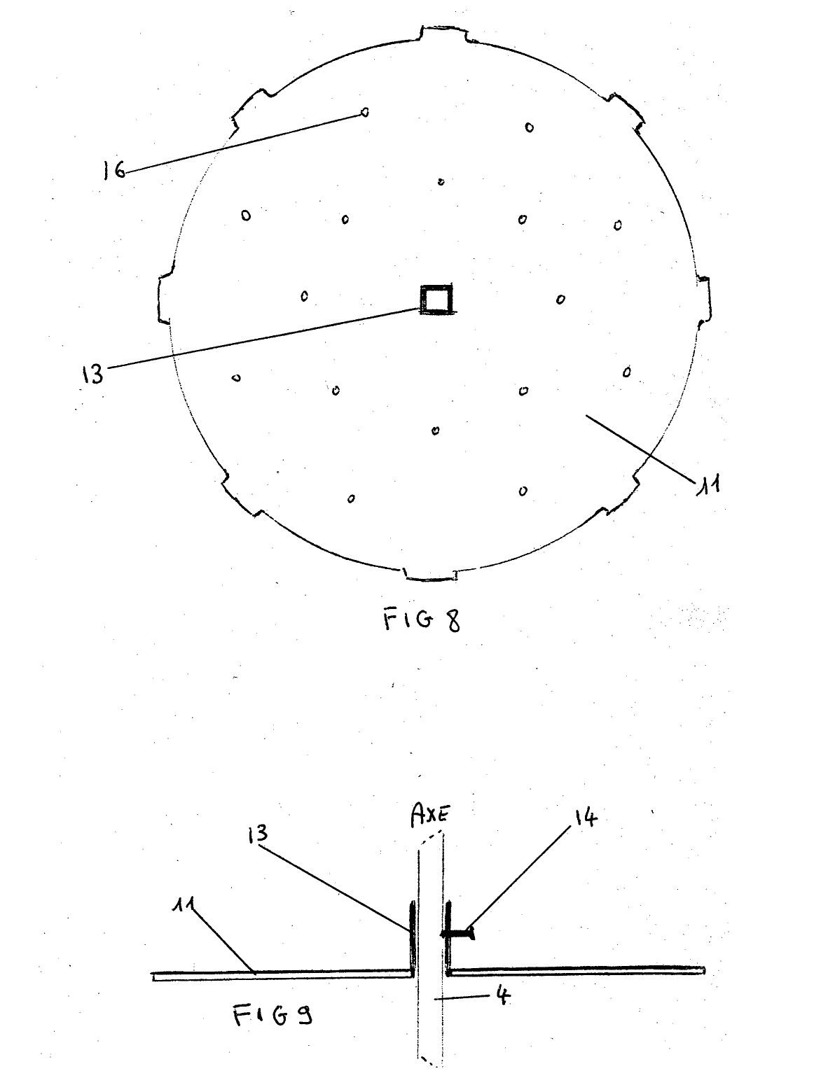

FIG. 8 represents the crenulated disc that supports the jacket (according to embodiment 2).

FIG. 9 represents the adjustment mechanism for the disc that supports the jacket (according to embodiment 2).

With reference to these drawings, the device includes a set of elements that constitute, according to embodiment 1, the kebab meat cover (FIG. 1), which consists of a layer made up of a multitude of pockets containing eutectic gel inside a jacket (1), the upper part of which surrounds a disc (2) made of a polyimide type of plastic, and which can be adjusted using laces (3). The disc (2) will have a hole in the centre so that it can slide onto the skewer (4) of the rotary spit. The crenulation (5) of the bottom of the jacket enables it to take on an overall cylindrical shape and permits the circulation of air (see end of description of primary characteristic). The jacket will be fastened by magnetized plastic male/female fasteners (6), which make the fastening almost invisible and are also easily washed and disinfected. The disc (2) will have holes for ventilation (7).

According to another variation not illustrated, the centre of the disc could be protected by a small silicone cover which would fit vertically into the centre of the disc. Advantageously, with reference to these drawings, the device includes a set of elements that constitute, according to embodiment 2, the kebab meat cover (FIG. 5), which consists of a layer composed of a multitude of pockets containing eutectic gel (8) as well as a thermal reflector (10) inside a jacket (9), the upper part of which surrounds a disc (11) made of plastic or stainless steel. The jacket will be fixed onto the crenulations around the disc, using the corresponding slits in the upper part of the jacket, and the device will be held together by fastening clips (12). The disc will have a hole in the centre so that it can slide onto the skewer (4) of the rotary spit by means of a square tube (13) on the skewer of the rotary spit.

Adjustment of the height of the disc on the skewer of the rotary spit will be made using a screw or a knob (14) provided with the disc.

For example (and without limitation), the size and weight of the kebab meat cover could vary depending on the weight and volume of the skewer to be refrigerated.

According to the invention, this device is specifically intended for the refrigeration and protection of a skewer of kebab meat once the rotary spit has been turned off, and by extension any food at risk from variations in temperature and exposure to bacteria, insects and dust.

1. Device for the refrigeration of kebab meat while it is still on the rotary spit, once the latter has stopped turning comprising a set of elements that form the kebab meat cover which limits exposure to air, insects and dust.

2. Device according to claim 1, further comprising a layer made up of a multitude of pockets containing eutectic gel, and frozen to −18° C., which will be inserted into a jacket that has crenulations at its lower end and is fastened by laces around the kebab meat skewer on the rotary spit or a layer made up of a multitude of pockets containing eutectic gel, and frozen to −18° C., as well as a thermal reflector, which will be inserted into a jacket that has slits located in its upper end.

3. Device according to claim 2, wherein the jacket, which contains the layer of eutectic gel, being positioned on a disc placed on the skewer of the rotary spit, or wherein the jacket, which contains the layer of eutectic gel as well as the thermal reflector being fixed onto the crenulation of the disc by means of corresponding slits located on the jacket, wherein the disc is positioned on the skewer of the rotary spit by means of a square tube, which is a constituent element of the disc and can be adjusted to the desired height using a screw or knob.

4. Device according to claim 2, wherein the jacket surrounding the skewer and being fastened by magnetized plastic male/female magnetic clips, or wherein the jacket being held around the disc by fastening clips.

5. Device according to claim 2, wherein the disc including ventilation, or wherein the disc including ventilation holes or slots on its surface, allowing the circulation of air necessary to the diffusion of coldness within the device.

6. Device according to claim 2, wherein the fact that all the materials used in the design of the kebab meat cover, and those parts that come into contact with food in particular, are food grade quality.

7. Device according to claim 2, wherein a layer of eutectic gel that is composed of a multitude of pockets and will have a different weight and volume in accordance with the skewer of kebab meat it is covering and the necessary length of refrigeration.

8. Device according to claim 2, wherein the thermal reflector being positioned between the layer of eutectic gel and the outer side of the jacket.
